(19) United States
(12) Patent Application Publication
(10) Pub. No.: US 2003/0101353 A1
(43) Pub. Date: May 29, 2003

(54) Method, computer-readable medium, and node for detecting exploits based on an inbound signature of the exploit and an outbound signature in response thereto

(76) Inventors: Richard Paul Tarquini, Apex, NC (US); Richard Louis Schertz, Raleigh, NC (US); George Simon Gales, Plano, TX (US)

Correspondence Address: HEWLETT-PACKARD COMPANY, Intellectual Property Administration, P.O. Box 272400, Fort Collins, CO, 80527-2400, US

(21) Appl. No.: 10/003,815

(22) Filed: Oct. 31, 2001

(51) Int. Cl. G06F 11/30

(52) U.S. Cl. 713/200

(57) ABSTRACT

A method of detecting an intrusion at a node of a network comprising reading a first packet received by the node, determining a first signature of the first packet, comparing the first signature with a signature file comprising a first machine-readable logic representative of a first packet signature, determining the first signature corresponds with the first machine readable logic, reading a second packet generated by the node in response to reception of the first packet, determining a second signature of the second packet, comparing the second signature with the signature file further comprising a second machine-readable logic representative of second packet signature, and determining the second signature corresponds with the second machine readable logic is provided. A computer-readable medium and a node for detecting an exploit based upon an outbound signature generated in response to an inbound signature of the exploit are also provided.

### CROSS-REFERENCE TO RELATED APPLICATIONS

This patent application is related to co-pending U.S. patent application Ser. No. ______, entitled “METHOD AND COMPUTER READABLE MEDIUM FOR SUPPRESSING EXECUTION OF SIGNATURE FILE DIRECTIVES DURING A NETWORK EXPLOIT,” filed Oct. 31, 2001, co-assigned herewith; U.S. patent application Ser. No. ______, entitled “SYSTEM AND METHOD OF DEFINING THE SECURITY CONDITION OF A COMPUTER SYSTEM,” filed Oct. 31, 2001, co-assigned herewith; U.S. patent application Ser. No. ______, entitled “SYSTEM AND METHOD OF DEFINING THE SECURITY VULNERABILITIES OF A COMPUTER SYSTEM,” filed Oct. 31, 2001, co-assigned herewith; U.S. patent application Ser. No. ______, entitled “SYSTEM AND METHOD OF DEFINING UNAUTHORIZED INTRUSIONS ON A COMPUTER SYSTEM,” filed Oct. 31, 2001, co-assigned herewith; U.S. patent application Ser. No. ______, entitled “NETWORK INTRUSION DETECTION SYSTEM AND METHOD,” filed Oct. 31, 2001, co-assigned herewith; U.S. patent application Ser. No. ______, entitled “NODE, METHOD AND COMPUTER READABLE MEDIUM FOR INSERTING AN INTRUSION PREVENTION SYSTEM INTO A NETWORK STACK,” filed Oct. 31, 2001, co-assigned herewith; U.S. patent application Ser. No. ______, entitled “NETWORK, METHOD AND COMPUTER READABLE MEDIUM FOR DISTRIBUTED SECURITY UPDATES TO SELECT NODES ON A NETWORK,” filed Oct. 31, 2001, co-assigned herewith; U.S. patent application Ser. No. ______, entitled “METHOD, COMPUTER READABLE MEDIUM, AND NODE FOR A THREE-LAYERED INTRUSION PREVENTION SYSTEM FOR DETECTING NETWORK EXPLOITS,” filed Oct. 31, 2001, co-assigned herewith; U.S. patent application Ser. No. ______, entitled “SYSTEM AND METHOD OF AN OS-INTEGRATED INTRUSION DETECTION AND ANTI-VIRUS SYSTEM,” filed Oct. 31, 2001, co-assigned herewith; U.S. patent application Ser. No. ______, entitled “METHOD, NODE AND COMPUTER READABLE MEDIUM FOR IDENTIFYING DATA IN A NETWORK EXPLOIT,” filed Oct. 31, 2001, co-assigned herewith; U.S. patent application Ser. No. ______, entitled “NODE, METHOD AND COMPUTER READABLE MEDIUM FOR OPTIMIZING PERFORMANCE OF SIGNATURE RULE MATCHING IN A NETWORK,” filed Oct. 31, 2001, co-assigned herewith; U.S. patent application Ser. No. ______, entitled “METHOD, NODE AND COMPUTER READABLE MEDIUM FOR PERFORMING MULTIPLE SIGNATURE MATCHING IN AN INTRUSION PREVENTION SYSTEM,” filed Oct. 31, 2001, co-assigned herewith; U.S. patent application Ser. No. ______, entitled “USER INTERFACE FOR PRESENTING DATA FOR AN INTRUSION PROTECTION SYSTEM,” filed Oct. 31, 2001, co-assigned herewith; U.S. patent application Ser. No. ______, entitled “NODE AND MOBILE DEVICE FOR A MOBILE TELECOMMUNICATIONS NETWORK PROVIDING INTRUSION DETECTION,” filed Oct. 31, 2001, co-assigned herewith; U.S. patent application Ser. No. ______, entitled “METHOD AND COMPUTER-READABLE MEDIUM FOR INTEGRATING A DECODE ENGINE WITH AN INTRUSION DETECTION SYSTEM,” filed Oct. 31, 2001, co-assigned herewith; U.S. patent application Ser. No. ______, entitled “SYSTEM AND METHOD OF GRAPHICALLY DISPLAYING DATA FOR AN INTRUSION PROTECTION SYSTEM,” filed Oct. 31, 2001, co-assigned herewith; and U.S. patent application Ser. No. ______, entitled “SYSTEM AND METHOD OF GRAPHICALLY CORRELATING DATA FOR AN INTRUSION PROTECTION SYSTEM,” filed Oct. 31, 2001, co-assigned herewith.

### TECHNICAL FIELD OF THE INVENTION

This invention relates to network technologies, and more particularly, to a method and computer-readable medium for detecting network-exploits based on an inbound signature of the exploit and a signature of response thereto.

### BACKGROUND OF THE INVENTION

Network-exploit attack tools, such as denial-of-service (DoS) attack utilities, are becoming increasing sophisticated and, due to evolving technologies, simple to execute. Relatively unsophisticated attackers can arrange, or be involved in, computer system compromises directed at one or more targeted facilities. A network system attack (also referred to herein as an intrusion) is an unauthorized or malicious use of a computer or computer network and may involve hundred or thousands of unprotected, or alternatively compromised, Internet nodes together in a coordinated attack on one or more selected targets.

Network attack tools based on the client/server model have become a preferred mechanism for executing network attacks on targeted networks or devices. High capacity machines in networks having deficient security are often desired by attackers to launch distributed attacks therefrom. University servers typically feature high connectivity and capacity but relatively mediocre security. Such networks also often have inexperienced or overworked network administrators making them even more vulnerable for involvement in network attacks.

Network-exploit attack tools, comprising hostile attack applications such as denial-of-service (DoS) utilities, responsible for transmitting data across a network medium will often have a distinctive “signature,” or recognizable pattern within the transmitted data. The signature may comprise a recognizable sequence of particular packets and/or recognizable data that is contained within one or more packets. Signature analysis is often performed by a network intrusion prevention system (IPS) and may be implemented as a pattern-matching algorithm and may comprise other signature recognition capabilities as well as higher-level application monitoring utilities. A simple signature analysis algorithm may search for a particular string that has been identified as associated with a hostile application. Once the string is identified within a network data stream, the one or more packets carrying the string may be identified as “hostile,” or exploitative, and the IPS may then perform any one or more of a number of actions, such as logging the identification of the frame, performing a countermeasure, or performing another data archiving or protection measure.

Intrusion prevention systems (IPS) encompass technology that attempts to identify exploits against a computer system or network of computer systems. Numerous types of IPSs exist and each are generally classified as either a network-based, host-based, or node-based IPS.

Network-based IPS appliances are typically dedicated systems placed at strategic places on a network to examine data packets to determine if they coincide with known attack signatures. To compare packets with known attack signatures, network-based IPS appliances utilize a mechanism referred to as passive protocol analysis to inconspicuously monitor, or “sniff,” all traffic on a network and to detect low-level events that may be discerned from raw network traffic. Network exploits may be detected by identifying patterns or other observable characteristics of network frames. Network-based IPS appliances examine the contents of data packets by parsing network frames and packets and analyzing individual packets based on the protocols used on the network. A network-based IPS appliance inconspicuously monitors network traffic inconspicuously, i.e., other network nodes may be, and often are, unaware of the presence of the network-based IPS appliance. Passive monitoring is normally performed by a network-based IPS appliance by implementation of a “promiscuous mode” access of a network interface device. A network interface device operating in promiscuous mode copies packets directly from the network media, such as a coaxial cable, 100baseT or other transmission medium, regardless of the destination node to which the packet is addressed. Accordingly, there is no simple method for transmitting data across the network transmission medium without the network-based IPS appliance examining it and thus the network-based IPS appliance may capture and analyze all network traffic to which it is exposed. Upon identification of a suspicious packet, i.e., a packet that has attributes corresponding to a known attack signature monitored for occurrence by the network-based IPS appliance, an alert may be generated thereby and transmitted to a management module of the IPS so that a networking expert may implement security measures. Network-based IPS appliances have the additional advantage of operating in real-time and thus can detect an attack as it is occurring. Moreover, a network-based IPS appliance is ideal for implementation of a state-based IPS security measure that requires accumulation and storage of identified suspicious packets of attacks that may not be identified “atomically,” that is by a single network packet. For example, transmission control protocol (TCP) synchronization (SYN) flood attacks are not identifiable by a single TCP SYN packet but rather are generally identified by accumulating a count of TCP SYN packets that exceed a predefined threshold over a defined period of time. A network-based IPS appliance is therefore an ideal platform for implementing state-based signature detection because the network-based IPS appliance may collect all such TCP SYN packets that pass over the local network media and thus may properly archive and analyze the frequency of such events.

However, network-based IPS appliances may often generate a large number of “false positives,” i.e., incorrect diagnoses of an attack. False positive diagnoses by network-based IPS appliances result, in part, due to errors generated during passive analysis of all the network traffic captured by the IPS that may be encrypted and formatted in any number of network supported protocols. Content scanning by a network-based IPS is not possible on an encrypted link although signature analysis based on protocol headers may be performed regardless of whether the link is encrypted or not. Additionally, network-based IPS appliances are often ineffective in high speed networks. As high speed networks become more commonplace, software-based network-based IPS appliances that attempt to sniff all packets on a link will become less reliable. Most critically, network-based IPS appliances can not prevent attacks unless integrated with, and operated in conjunction with, a firewall protection system.

Host-based IPSs detect intrusions by monitoring application layer data. Host-based IPSs employ intelligent agents to continuously review computer audit logs for suspicious activity and compare each change in the logs to a library of attack signatures or user profiles. Host-based IPSs may also poll key system files and executable files for unexpected changes. Host-based IPSs are referred to as such because the IPS utilities reside on the system to which they are assigned to protect. Host-based IPSs typically employ application-level monitoring techniques that examine application logs maintained by various applications. For example, a host-based IPS may monitor a database engine that logs failed access attempts and/or modifications to system configurations. Alerts may be provided to a management node upon identification of events read from the database log that have been identified as suspicious. Host-based IPSs, in general, generate very few false-positives. However, host-based IPS such as log-watchers are generally limited to identifying intrusions that have already taken place and are also limited to events occurring on the single host. Because log-watchers rely on monitoring of application logs, any damage resulting from the logged attack will generally have taken place by the time the attack has been identified by the IPS. Some host-based IPSs may perform intrusion-preventative functions such as ‘hooking’ or ‘intercepting’ operating system application programming interfaces to facilitate execution of preventative operations by an IPS based on application layer activity that appears to be intrusion-related. Because an intrusion detected in this manner has already bypassed any lower level IPS, a host-based IPS represents a last layer of defense against network exploits. However, host-based IPSs are of little use for detecting low-level network events such as protocol events.

Node-based IPSs apply the intrusion detection and/or prevention technology on the system being protected. An example of node-based IPS technologies is inline intrusion detection. A node-based IPS may be implemented at each node of the network that is desired to be protected. Inline IPSs comprise intrusion detection technologies embedded in the protocol stack of the protected network node. Because the inline IPS is embedded within the protocol stack, both inbound and outbound data will pass through, and be subject to monitoring by, the inline IPS. An inline IPS overcomes many of the inherent weaknesses of network-based solutions. As mentioned hereinabove, network-based solutions are generally ineffective when monitoring high-speed networks due to the fact that network-based solutions attempt to monitor all network traffic on a given link. Inline intrusion prevention systems, however, only monitor traffic directed to the node on which the inline IPS is installed. Thus, attack packets can not physically bypass an inline IPS on a targeted machine because the packet must pass through the protocol stack of the targeted device. Any bypassing of an inline IPS by an attack packet must be done entirely by ‘logically’ bypassing the IPS, i.e., an attack packet that evades an inline IPS must do so in a manner that causes the inline IPS to fail to identify, or improperly identify, the attack packet. Additionally, inline IPSs provide the hosting node with low-level monitoring and detection capabilities similar to that of a network IPS and may provide protocol analysis and signature matching or other low-level monitoring or filtering of host traffic. The most significant advantage offered by inline IPS technologies is that attacks are detected as they occur. Whereas host-based IPSs determine attacks by monitoring system logs, inline intrusion detection involves monitoring network traffic and isolating those packets that are determined to be part of an attack against the hosting server and thus enabling the inline IPS to actually prevent the attack from succeeding. When a packet is determine to be part of an attack, the inline IPS layer may discard the packet thus preventing the packet from reaching the upper layer of the protocol stack where damage may be caused by the attack packet—an effect that essentially creates a local firewall for the server hosting the inline IPS and protecting it from threats coming either from an external network, such as the Internet, or from within the network. Furthermore, the inline IPS layer may be embedded within the protocol stack at a layer where packets have been unencrypted so that the inline IPS is effective operating on a network with encrypted links. Additionally, inline IPSs can monitor outgoing traffic because both inbound and outbound traffic respectively destined to and originating from a server hosting the inline IPS must pass through the protocol stack.

Although the advantages of inline IPS technologies are numerous, there are drawbacks to implementing such a system. Inline intrusion detection is generally processor intensive and may adversely effect the node's performance hosting the detection utility. Additionally, inline IPSs may generate numerous false positive attack diagnoses. Furthermore, inline IPSs cannot detect systematic probing of a network, such as performed by reconnaissance attack utilities, because only traffic at the local server hosting the inline IPS is monitored thereby.

Each of network-based, host-based and inline-based IPS technologies have respective advantages as described above. Ideally, an intrusion prevention system will incorporate all of the aforementioned intrusion detection strategies. Additionally, an IPS may comprise one or more event generation mechanisms that report identifiable events to one or more management facilities. An event may comprise an identifiable series of system or network conditions or it may comprise a single identified condition. An IPS may also comprise an analysis mechanism or module and may analyze events generated by the one or more event generation mechanisms. A storage module may be comprised within an IPS for storing data associated with intrusion-related events. A countermeasure mechanism may also be comprised within the IPS for executing an action intended to thwart, or negate, a detected exploit.

Typical computer network attacks involve reconnaissance attacks prior to launching the actual network attack. A reconnaissance attack is performed to collect information on the network that is later used to facilitate the actual network attack. In general, a reconnaissance attack attempts to determine information regarding DNS and web servers, firewall access control lists (ACLs), IPS information, internal network configuration, trust relationships, operating systems, applications running on specific nodes as well as other general network information that may assist the attacker in exploiting network security weaknesses in an attack thereon. For example, a common network tool that is often used by an attacker during reconnaissance attacks is NMAP. NMAP is a networking tool used to obtain information about hosts on a network by issuing a series of queries, or probes, to the host's protocol stack. NMAP probes, and probes of other reconnaissance utilities, are particularly resistant to detection and or prevention by an IPS due to the fact that the reconnaissance utilities often have legitimate uses when utilized by a network administrator or security personnel within the probed network and, accordingly, many probe packets are often legitimately formatted. Accordingly, prior art IPSs are often unable to distinguish reconnaissance probes from normal TCP session traffic. Reconnaissance applications such as NMAP operate by sending one or more probe packets to the network stack of a host and reading the response provided thereby. Dependent on the particular response to the probe packet, the reconnaissance utility is often able to determine what operating system the targeted host is running in addition to what ports are open and other information by comparing the response of the host with a database of known responses of various operating system network stack responses. Once the particular network stack is identified, malicious attacks may be launched thereagainst by known security flaws of the identified operating system. NMAP is often able to determine what operating system a host is running and what network ports are open, as well as other information, by the particular response returned by the probed host. Known security holes may then be exploited by the attacker upon procurement of this information. Because network tools such as NMAP have legitimate uses and due to the fact that the queries issued thereby are valid network probes, an IPS is unable to isolate the probes from normal TCP connection sessions on the receiving side of the probed host and is thus unable to detect exploitative uses thereof.

### SUMMARY OF THE INVENTION

In accordance with an embodiment of the present invention, a method of detecting an intrusion at a node of a network comprising reading a first packet received by the node, determining a first signature of the first packet, comparing the first signature with a signature file comprising a first machine-readable logic representative of a first packet signature, determining the first signature corresponds with the first machine readable logic, reading a second packet generated by the node in response to reception of the first packet, determining a second signature of the second packet, comparing the second signature with the signature file further comprising a second machine-readable logic representative of second packet signature, and determining the second signature corresponds with the second machine readable logic is provided.

In accordance with another embodiment of the present invention, a computer-readable medium having stored thereon a set of instructions to be executed, the set of instructions, when executed by a processor, cause the processor to perform a computer method of reading a first packet, determining a first signature of the first packet, comparing the first signature with a first instruction set comprising a first set of machine readable logic representative of a first packet signature, determining the first signature corresponds with the first set of machine readable logic, reading a second packet, determining a second signature of the second packet, comparing the second signature with a second instruction set comprising a second set of machine readable logic representative of a second packet signature, and determining the second signature corresponds with the second set of machine readable logic is provided.

In accordance with another embodiment of the present invention, a node of a network operable to detect an intrusion thereof is provided, the node comprising a central processing unit, a memory module for storing data in machine readable format for retrieval and execution by a central processing unit, and an operating system comprising a network stack comprising a protocol driver, a media access control driver and a network filter service provider bound to the protocol driver and the media access control driver, the network filter service provider operable to receive a first packet and to determine a first signature of the first packet and compare the first signature with a first instruction set comprising a first set of machine readable logic representative of a first packet signature and to determine a correspondence with the first set of machine readable logic, the network filter service provider further operable to receive a second packet and to determine a second signature of the second packet and compare the second signature with a second instruction set comprising a second set of machine readable logic representative of a second packet signature and to determine a correspondence with the second set of machine readable logic, the processor operable to execute a directive comprised of machine readable instructions upon determination, by the network filter service provider, of a correspondence between the first signature and the first instruction set and correspondence between the second signature and the second instruction set.

In accordance with another embodiment of the present invention, a method of detecting an intrusion at a node of a network comprising reading a packet by the node, determining a signature of the packet, comparing the signature with a signature file comprising a machine-readable logic representative of a packet signature, and determining the signature corresponds with the machine readable logic is provided.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 illustrates an exemplary arrangement for executing a computer system compromise according to the prior art;

FIG. 2 illustrates a comprehensive intrusion prevention system employing network-based and hybrid host-based and node based intrusion detection technologies according to an embodiment of the invention;

FIG. 3 is an exemplary network protocol stack according to the prior art;

FIG. 4 illustrates a network node that may run an instance of an intrusion protection system application according to an embodiment of the present invention;

FIG. 5 illustrates an exemplary network node that may operate as a management node within a network protected by the intrusion protection system according to an embodiment of the present invention; and

FIG. 6 illustrates an exemplary protocol stack having an intrusion protection system inserted therein for performing a signature analysis process according to an embodiment of the present invention.

### DETAILED DESCRIPTION OF THE DRAWINGS

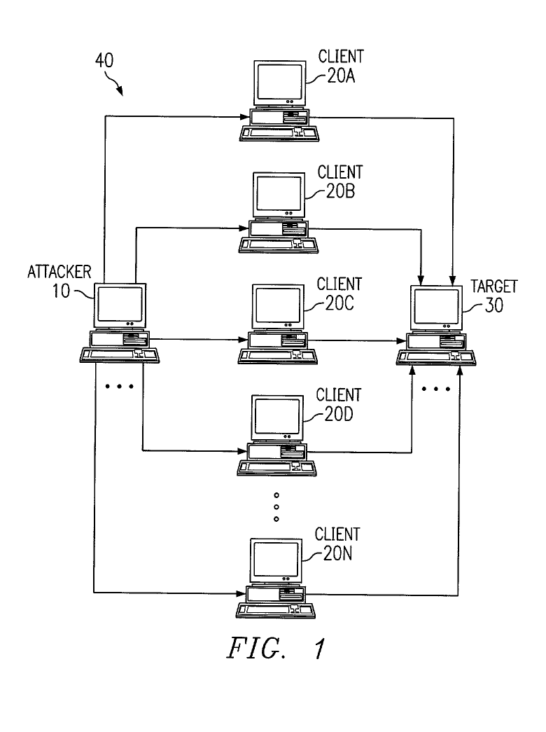

The preferred embodiment of the present invention and its advantages are best understood by referring to FIGS. 1 through 6 of the drawings, like numerals being used for like and corresponding parts of the various drawings.

In FIG. 1, there is illustrated an exemplary arrangement for executing a computer system compromise—the illustrated example showing a simplified distributed intrusion network 40 arrangement typical of distributed system attacks directed at a target machine 30. An attack machine 10 may direct execution of a distributed attack by any number of attack agents 20A-20N by one of numerous techniques such as remote control by IRC “robot” applications. Attack agents 20A-20N, also referred to as “zombies” and “attack agents,” are generally computers that are available for public use or that have been compromised such that a distributed attack may be launched upon command of an attack machine 10. Numerous types of distributed attacks may be launched against a target machine 30. The target machine 30 may suffer extensive damage from simultaneous attack by attack agents 20A-20N and the attack agents 20A-20N may be damaged from the client attack application as well. A distributed intrusion network may comprise an additional layer of machines involved in an attack intermediate the attack machine 10 and attack agents 20A-20N. These intermediate machines are commonly referred to as “handlers” and each handler may control one or more attack agents 20A-20N. The arrangement shown for executing a computer system compromise is illustrative only and may compromise numerous arrangements that are as simple as a single attack machine 10 attacking a target machine 30 by, for example, sending malicious probe packets or other data intended to compromise target machine 30. Target machine may be, and often is, connected to a larger network and access thereto by attack machine 10 may cause damage to a large collection of computer systems commonly located within the network.

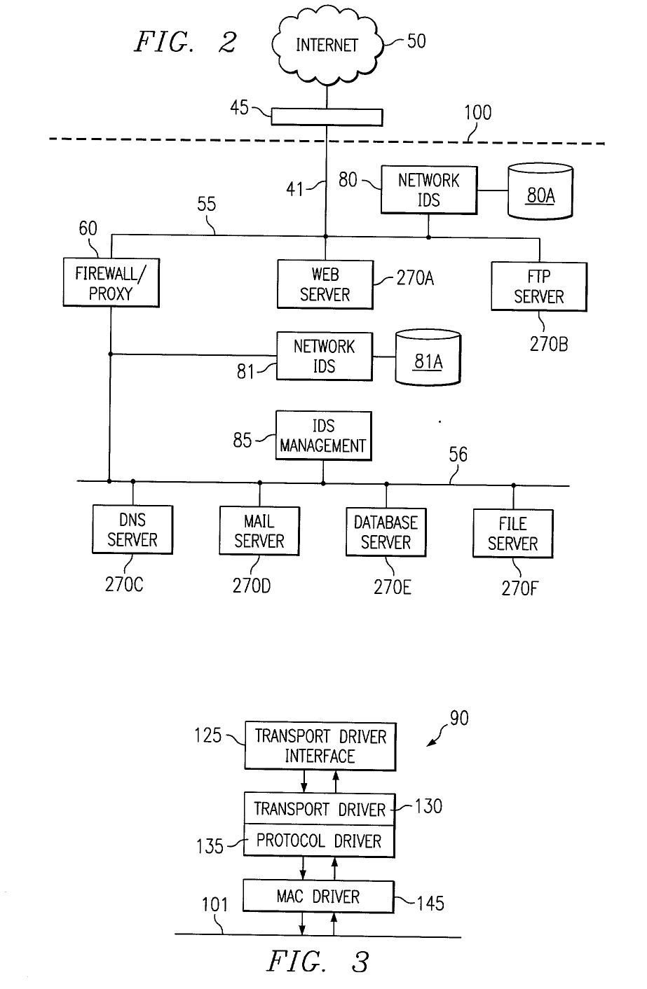

In FIG. 2, there is illustrated a comprehensive intrusion prevention system employing network-based and hybrid host-based/node-based intrusion detection technologies according to an embodiment of the invention. One or more networks 100 may interface with the Internet 50 via a router 45 or other device. In the illustrative example, two Ethernet networks 55 and 56 are comprised in network 100. Ethernet network 55 comprises a web-content server 270A and a file transport protocol-content server 270B. Ethernet network 56 comprises a domain name server 270C, a mail server 270D, a database sever 270E and a file server 270F. A firewall/proxy router 60 disposed intermediate Ethernets 55 and 56 provides security and address resolution to the various systems of network 56. A network-based IPS appliance 80 and 81 is respectively implemented on both sides of firewall/proxy router 60 to facilitate monitoring of attempted attacks against one or more elements of Ethernets 55 and 56 and to facilitate recording successful attacks that successfully penetrate firewall/proxy router 60. Network-based IPS appliances 80 and 81 may respectively comprise (or alternatively be connected to) a database 80A and 81A of known attack signatures, or rules, against which network frames captured thereby may be compared. Alternatively, a single database (not shown) may be centrally located within network 100 and may be accessed by network-based IPS appliances 80 and 81. Accordingly, network-based IPS appliance 80 may monitor all packets inbound from Internet 50 to network 100 arriving at Ethernet network 55. Similarly, a network-based IPS appliance 81 may monitor and compare all packets passed by firewall/proxy router 60 for delivery to Ethernet network 56. An IPS management node 85 may also be part of network 100 to facilitate configuration and management of the IPS components in network 100.

In view of the above-noted deficiencies of network-based intrusion prevention systems, a hybrid host-based and node-based intrusion prevention system is preferably implemented within each of the various nodes, such as servers 270A-270N (also referred to herein as “nodes”), of Ethernet networks 55 and 56 in the secured network 100. Management node 85 may receive alerts from respective nodes within network 100 upon detection of an intrusion event by any one of the network-based IPS appliances 80 and 81 as well as any of the nodes of network 100 having a hybrid agent-based and node-based IPS implemented thereon. Additionally, each node 270A-270F may respectively employ a local file system for archiving intrusion-related events, generating intrusion-related reports, and storing signature files against which local network frames and/or packets are examined.

Preferably, network-based IPS appliances 80 and 81 are dedicated entities for monitoring network traffic on associated Ethernets 55 and 56 of network 100. To facilitate intrusion detection in high speed networks, network-based IPS appliances 80 and 81 preferably comprise a large capture RAM for capturing packets as they arrive on respective Ethernet networks 55 and 56. Additionally, it is preferable that network-based IPS appliances 80 and 81 respectively comprise hardware-based filters for filtering network traffic, although IPS filtering by network-based IPS appliances 80 and 81 may be implemented in software. Moreover, network-based IPS appliances 80 and 81 may be configured, for example by demand of IPS management node 85, to monitor one or more specific devices rather than all devices on a common network. For example, network-based IPS appliance 80 may be directed to monitor only network data traffic addressed to web server 270A.

Hybrid host-based/node-based intrusion prevention system technologies may be implemented on all nodes 270A-270N on Ethernet networks 55 and 56 that may be targeted by a network attack. In general, each node is comprised of a reprogrammable computer having a central processing unit (CPU), a memory module operable to store machine-readable code that is retrievable and executable by the CPU, and may further comprise various peripheral devices, such as a display monitor, a keyboard, a mouse or another device, connected thereto. A storage media, such as a magnetic disc, an optical disc or another component operable to store data, may be connected to memory module and accessible thereby and may provide one or more databases for archiving local intrusion events and intrusion event reports. An operating system may be loaded into memory module, for example upon bootup of the respective node, and comprises an instance of a protocol stack as well as various low-level software modules required for tasks such as interfacing to peripheral hardware, scheduling of tasks, allocation of storage as well as other system tasks. Each node protected by the hybrid host-based and node-based IPS of the present invention accordingly has an IPS software application maintained within the node, such as in a magnetic hard disc, that is retrievable by the operating system and executable by the central processing unit. Additionally, each node executing an instance of the IPS application has a local database from which signature descriptions of documented attacks may be fetched from storage and compared with a packet or frame of data to detect a correspondence therebetween. Detection of a correspondence between a packet or frame at an IDS server may result in execution of any one or more of various security procedures.

The IPS described with reference to FIG. 2 may be implemented on any number of platforms. Each hybrid host-based/node-based instance of the IPS application described herein is preferably implemented on a network node, such as web server 270A operated under control of an operating system, such as Windows NT 4.0 that is stored in a main memory and running on a central processing unit, and attempts to detect attacks targeted at the hosting node. The particular network 100 illustrated in FIG. 2 is exemplary only and may comprise any number of network servers. Corporate, and other large scale, networks may typically comprise numerous individual systems providing similar services. For example, a corporate network may comprise hundreds of individual web servers, mail servers, FTP servers and other systems providing common data services.

Each operating system of a node incorporating an instance of an IPS application additionally comprises a network protocol stack 90, as illustrated in FIG. 3, that defines the entry point for frames received by a targeted node from the network, e.g. the Internet or Intranet. Network stack 90 as illustrated is representative of the well-known WindowsNT (TM) system network protocol stack and is so chosen to facilitate discussion and understanding of the invention. However, it should be understood that the invention is not limited to a specific implementation of the illustrated network stack 90 but, rather, stack 90 is described to facilitate understanding of the invention. Network stack 90 comprises a transport driver interface (TDI) 125, a transport driver 130, a protocol driver 135 and a media access control (MAC) driver 145 that interfaces with the physical media 101. Transport driver interface 125 functions to interface the transport driver 130 with higher-level file system drivers. Accordingly, TDI 125 enables operating system drivers, such as network redirectors, to activate a session, or bind, with the appropriate protocol driver 135. Accordingly, a redirector can access the appropriate protocol, for example UDP, TCP, NetBEUI or other network or transport layer protocol, thereby making the redirector protocol-independent. The protocol driver 135 creates data packets that are sent from the computer hosting the network protocol stack 90 to another computer or device on the network or another network via the physical media 101. Typical protocols supported by an NT network protocol stack comprise NetBEUI, TCP/IP, NWLink, Data Link Control (DLC) and AppleTalk although other transport and/or network protocols may be comprised. MAC driver 145, for example an Ethernet driver, a token ring driver or other networking driver, provides appropriate formatting and interfacing with the physical media 101 such as a coaxial cable or another transmission medium.

The capabilities of the host-based IPS comprise application monitoring of: file system events; registry access; successful security events; failed security events and suspicious process monitoring. Network access applications, such as Microsoft IIS and SQL Server, may also have processes related thereto monitored.

Intrusions may be prevented on a particular IPS host by implementation of inline, node-based monitoring technologies. The inline-IPS is preferably comprised as part of a hybrid host-based/node-based IPS although it may be implemented independently of any host-based IPS system. The inline-IPS will analyze packets received at the hosting node and perform signature analysis thereof against a database of known signatures by network layer filtering.

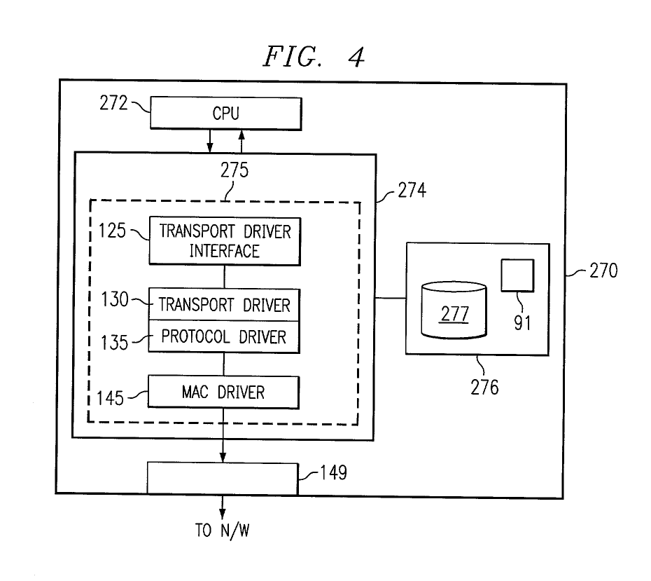

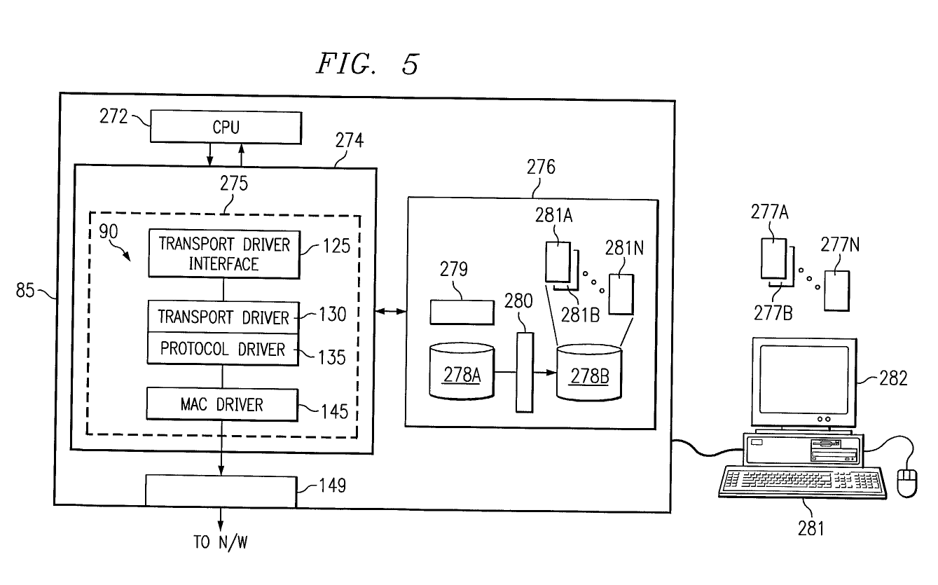

In FIG. 4, there is illustrated a network node 270 that may run an instance of an IPS application 91 and thus operate as an IPS server. IPS application 91 may be implemented as a three-layered IPS, as described in co-pending application entitled “Method and Computer Readable Medium for a Three-Layered Intrusion Prevention System for Detecting Network Exploits” and filed concurrently herewith, and may comprise a server application and/or a client application. Network node 270, in general, comprises a central processing unit (CPU) 272 and a memory module 274 operable to store machine-readable code that is retrievable and executable by CPU 272 via a bus (not shown). A storage media 276, such as a magnetic disc, an optical disc or another component operable to store data, may be connected to memory module 274 and accessible thereby by the bus as well. An operating system 275 may be loaded into memory module 274, for example upon bootup of node 270, and comprises an instance of protocol stack 90 and may have an intrusion prevention system application 91 loaded from storage media 276. One or more network exploit rules, an exemplary form described in co-pending application entitled “Method, Node and Computer Readable Medium for Identifying Data in a Network Exploit” and filed concurrently herewith, may be compiled into a machine-readable signature(s) and stored within a database 277 that is loadable into memory module 274 and may be retrieved by IPS application 91 for facilitating analysis of network frames and/or packets.

In FIG. 5, there is illustrated an exemplary network node that may operate as a management node 85 of the IPS of a network 100. Management node 85, in general, comprises a CPU 272 and a memory module 274 operable to store machine-readable code that is retrievable and executable by CPU 272 via a bus (not shown). A storage media 276, such as a magnetic disc, an optical disc or another component operable to store data, may be connected to memory module 274 and accessible thereby by the bus as well. An operating system 275 may be loaded into memory module 274, for example upon bootup of node 85, and comprises an instance of protocol stack 90. Operating system 275 is operable to fetch an IPS management application 279 from storage media 276 and load management application 279 into memory module 274 where it may be executed by CPU 272. Node 85 preferably has an input device 281, such as a keyboard, and an output device 282, such as a monitor, connected thereto.

An operator of management node 85 may input one or more text-files 277A-277N via input device 281. Each text-file 277A-277N may define a network-based exploit and comprise a logical description of an attack signature as well as IPS directives to execute upon an IPS evaluation of an intrusion-related event associated with the described attack signature. Each text file 277A-277N may be stored in a database 278A on storage media 276 and compiled by a compiler 280 into a respective machine-readable signature file 281A-281N that is stored in a database 278B. Each of the machine-readable signature files 281A-281N comprises binary logic representative of the attack signature as described in the respectively associated text-file 277A-277N. An operator of management node 85 may periodically direct management node 85, through interaction with a client application of IPS application 279 via input device 281, to transmit one or more machine-readable signature files (also generally referred to herein as “signature files”) stored in database 278B to a node, or a plurality of nodes, in network 100. Alternatively, signature files 281A-281N may be stored on a computer-readable medium, such as a compact disk, magnetic floppy disk or another portable storage device, and installed on node 270 of network 100. Application 279 is preferably operable to transmit all such signature-files 281A-281N, or one or more subsets thereof, to a node, or a plurality of nodes, in network 100. Preferably, IPS application 279 provides a graphical user interface on output device 282 for facilitating input of commands thereto by an operator of node 85.

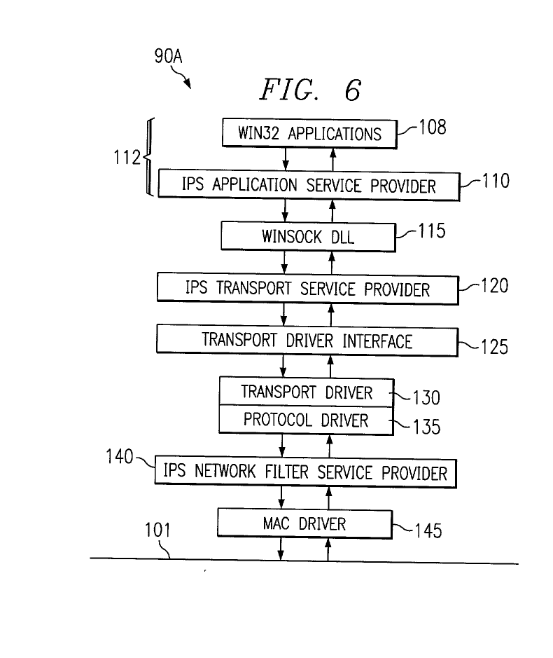

In FIG. 6, there is illustrated an exemplary protocol stack 90A having an intrusion protection system including an IPS module implemented as an intermediate driver inserted therein and in which a signature analysis process may be employed according to the teachings of the invention. Network stack 90A comprises TDI 125, a transport driver 130, a protocol driver 135 and a media access control (MAC) driver 145 that interfaces with the physical media 101. Transport driver interface 125 functions to interface the transport driver 130 with higher level file system drivers and enables operating system drivers to bind with an appropriate protocol driver 135. Protocol driver 135 creates data packets that are sent from the computer hosting network protocol stack 90A to another computer or device on the network or another network via physical media 101. MAC driver 145, for example an Ethernet driver, a token ring driver or another networking driver, provides appropriate formatting and interfacing with the physical media 101 such as a coaxial cable or another transmission medium. Network stack 90A additionally may comprise a dynamically linked library 115 that allows a plurality of subroutines to be accessed by applications 105, comprising an IPS server, at application layer 112 of network stack 90A and facilitates linking with other applications 108 thereby. An intrusion prevention system network filter service provider 140 is installed above the physical media driver 145, such as an Ethernet driver, token ring driver, etc., and bound thereto. Intrusion prevention system network filter service provider 140 is bound to protocol driver 135 as well. Thus, all machine-readable signature files maintained in database 277 may thereby be validated against incoming and outgoing frames. IPS network filter service provider 140 provides low level filtering to facilitate suppression of network attacks comprising “atomic” network attacks, network protocol level attacks, IP port filtering and also serves to facilitate collection of network statistics. Accordingly, by implementing a filter service provider 140 of the IPS at the network layer of network stack 90A, the IPS observes identical data that the network stack processes and is able to suppress inbound and/or outbound data at the network layer. Accordingly, filter service provider 140 may evaluate execution of IPS services based on processing behavior of the network stack.

Network filter service provider 140 may comprise one or more functional layers such as an input/output management layer for receiving signature files from an IPS server at application layer 112 executed by CPU 272 and for transmitting identification of intrusion-related events to the IPS, an intrusion event manager for directing handling of intrusion-related events of the network filter service provider 140, an associative process engine for performing identification of network layer intrusion events such as performing signature analysis on frames received by network filter service provider 140 through invocation of a pattern matching algorithm or other signature recognition technique and a subnet filter.

IPS transport service provider 120 is preferably a windows layered service provider and provides a layer of filtering intermediate network filter service provider 140 and IPS application service provider 110. IPS transport service provider 120 may provide network exploit detection at the transport layer level. For example, IPS transport service provider 120 may comprise layered serviced provider filters to facilitate socket level filtering. By including IPS transport service provider 120 within IPS application 91, IPS application 91 may filter frames at a node of network 100 after reassembly of the constituent network packets and after unencryption thereof has been performed. Accordingly, IPS transport service provide layer 120 may detect attacks, such as multiframe attacks and fragmented attacks, that do not have signatures that are easily detectable over a single packet or series of packets, but that may be detected by filtering an exploitative, unencrypted frame comprised of assembled packets.

IPS network filter service provider 140 and/or IPS transport service provider 120 shown in FIG. 6 may be utilized to prevent reconnaissance attacks. The present invention provides detection of reconnaissance packets by defining outbound signatures as well as inbound signatures so that reconnaissance probes that are indistinguishable from normal network traffic may be identified by the response of the host receiving the probe packet. IPS network filter service provider 140 may detect reconnaissance probe packets inbound on a particular network device and prevent the probes from penetrating the hosts' network stack by identifying a signature of the inbound probe packet. IPS network filter service provider 140 of the present invention may additionally detect reconnaissance probes that appear to be legitimate TCP traffic, i.e. indistinguishable based on the inbound signature of the probe packet, by identifying the response to the packet probe by an outbound response signature and, accordingly, the response may be suppressed such that the response to the reconnaissance probe is never transmitted to the interrogating reconnaissance agent. Alternatively, IPS network filter service provider 140 may detect a reconnaissance probe solely by identification of an inbound or outbound signature thereof. IPS transport service provider 120 may perform similar functions as IPS network filter service provider 140 but the functions thereof are distinguished from network filter service provider 140 in that transport service provider 120 may perform signature matching against unencrypted network frames that have been reassembled from the constituent packets.

NMAP is strictly an exemplary reconnaissance utility. Discussion of the present invention with respect to detecting and suppressing a response to a reconnaissance probe issued by NMAP is illustrative only and the present invention may be effectively implemented to suppress network stack responses to numerous reconnaissance utilities other than NMAP that rely on a network stack response to a probe packet in order to obtain information regarding the probed network stack or operating system. Additionally, the description herein of signature matching based on the exemplary NMAP utility illustrates signature matching performed on a packet-basis and is described as such for simplification of discussion only. Signature matching performed on reassembled and unencrypted frames may likewise be performed by transport service provider 120 of IPS application 91.

NMAP is operable to perform numerous network scanning routines by sending a series of carefully designed TCP packets, or probes, to one or more hosts of the targeted system. The responses from the targeted system are then compared against a database of operating system fingerprints maintained by NMAP and the operating system of the targeted host, as well as other information such as open ports, identification of ports that are filtered or unfiltered, and other network security-sensitive information may then be determined.

NMAP has numerous utilities and may issue one or more of numerous probe packets to a targeted node. In general, NMAP will first determine an open port and a closed port on the targeted system. This may be accomplished by NMAP in a number of ways comprising a TCP connect scan and a TCP SYN scan. A TCP connect scan utilizes a connect system call available on the attackers operating system to attempt to open a TCP connection on selected ports of the targeted system. The connect will either succeed or fail dependent on whether the port is available or not. A TCP SYN scan may alternatively be used to determine open ports on a targeted system. The TCP SYN scan is similar to the TCP connect scan but differs in that a full connection is not opened but, rather, the TCP SYN scan only performs a half-open connection. A SYN packet is transmitted to a desired port. The attacker awaits for SYN ACK that indicates the port is open. A RST transmitted back to the attacker indicates the port is unavailable. In the event a SYN ACK is received, the TCP SYN scan immediately transmits a RST to tear down the connection. An advantage, from the attackers perspective, is that the TCP SYN scan is less likely to draw attention from the system administrator of the targeted system because the TCP SYN scan is less likely to be logged since the TCP connection is never filly established.

Upon determination of an open port and a closed port, NMAP can begin operating system identification by sending probes to the identified open and closed port. For example, a first packet of a NMAP reconnaissance attack sent to an identified open port is typically a SYN packet—the normal procedure for opening a TCP session. The second NMAP probe, commonly referred to as a null scan, is a TCP packet with no flags asserted. The third probe to an open port comprises SYN, FIN, PSH, and URG flags asserted. Various operating systems will respond in different manners to these probe packets sent to an open port. Identification of the operating system may be made dependent on these response. For example, a null scan transmitted to an open port should be ignored by an open port according to published networking standards such as RFC 794. However, some operating systems deviate from the standards. In this particular example, a Microsoft (TM) operating system will typically return a RST rather than dropping the null packet. Other operating systems that deviate from published standards in response to a null scan comprise Cisco, BSDI, HP/UX, MVS and IRIX—all respond to the null packet with a RST. Thus, the responses to each of the probe packets is stored by NMAP and the operating system may be determined by comparing the response to the various NMAP probes. Similarly, transmission of probe packets to closed ports likewise provides information regarding the particular operating system and, in conjunction with the probes sent to the open ports, facilitates analysis of the particular operating system running on the targeted machine.

In general, NMAP may be used as a port scanner and/or an OS identifier. One of the most notable signatures of NMAP is that it sets the acknowledgment number in the TCP header of an ACK probe packet, that is a TCP packet having the ACK flag asserted, to zero during a port scan. In legitimate TCP packets, the acknowledgment number is generally greater than 1 when the ACK flag is asserted and, thus, identification of a TCP packet having a zeroed acknowledgment number and an asserted ACK flag may provide an indication that the subject packet is likely involved in an NMAP probe.

The impetus for NMAP to comprise such a recognizable signature may be understood by reference to RFC 793. TCP responses to specific packets are defined in RFC 793 and define two TCP states: listening and closed. A port in a listening state should generally drop any packets to the listening port that comprise an asserted RST flag and to return a RST packet in response to any incoming packet containing an asserted ACK flag. Additionally, if a SYN bit is asserted, a RST packet is returned if the incoming packet is not allowed and a SYN/ACK packet is returned if the incoming packet is allowed, such as in the common TCP three-way handshake.

As described hereinabove, an IPS application 91 of the present invention may perform signature matching on network frames by implementing a pattern matching algorithm, or other signature recognition technology. Preferably, signature files 281A-281N generated from compilation of text-files comprising text descriptions of attack signatures are passed to network filter service provider where a signature recognition technique is performed. Network filter service provider 140 and/or transport service provider 120 may detect reconnaissance probes by having signature files passed thereto that may comprise machine-readable code representative of an inbound signature of a reconnaissance probe and machine-readable code representative of an outbound signature of a network stack response to the reconnaissance probe. Accordingly, detection of the inbound reconnaissance probe signature and a subsequent detection of an outbound response signature generated by the probed network stack in response to the probe packet and/or frame may allow the IPS to affirmatively evaluate the probe packet and/or frame as a reconnaissance attack. Furthermore, the network filter service provider 140 is bound to the protocol driver and the media access control driver. Accordingly, the probe packet must pass through the network filter service provider 140 and the response generated thereby must pass therethrough as well. As the probe packet is passed to the protocol driver by the media access control driver 145, the network filter service provider may perform a signature analysis on the packet. Likewise, as the response packet generated by network stack 90 is passed to media access control driver 145, it first passes through network filter service provider 140 where a signature analysis may be made on it as well. A correspondence between the analyzed signature of the probe packet and an inbound reconnaissance probe signature maintained in a signature file and a correspondence between an analyzed signature of the response packet generated by network stack 90A and an outbound response signature maintained in the signature file may invoke network filter service provider 140 to perform a directive maintained in the signature file, such as logging of the identified reconnaissance probe, discarding of the response packet and/or execution of another security measure. Preferably, network filter service provider 140 discards the response packet such that it never reaches the media access control driver and, thus, is not delivered to the probing agent thereby thwarting information collection of the probed network or system by the reconnaissance utility.

In TABLE A, there is shown an exemplary text-based description of an NMAP signature that may be included within text file 277A and compiled into a machine-readable signature-file 281A for comparison with an analyzed signature of a packet and/or frame passed to network filter provider 140 and/or transport service provider 120 by media access control driver 145. The NMAP signature description comprises an inbound signature that may correspond with a probe packet transmitted by an NMAP agent to a targeted node of a network. The NMAP description may also comprise an outbound signature that may correspond with a response packet generated by the network stack of the probed host in response to receiving the probe packet. The text-based description for an example suspect inbound signature corresponds to an analyzed packet identified as a TCP packet with the 32-bit acknowledgment number of the identified TCP packet to be set to zero by the following condition:

((tcp)&&(tcp[8:4]=0)).

Correspondence of an analyzed signature of a packet with the inbound signature of the text-based signature description is contingent on an identified TCP packet with an acknowledgment number set to zero and any one of the following asserted flag(s):

1) Acknowledgment

2) Finish and Acknowledgment

3) Synchronization and Acknowledgment

4) Reset and Acknowledgment

by logically ANDing the TCP packet requirement and zeroed acknowledgment number with the respective following bitwise operations, each logically ORed:

| | | | |
|---|---|---|---|
| 1) | ((tcp[13:1] & 0x10) = 0x10) | ∥ | //ACK |
| 2) | ((tcp[13:1] & 0x11) = 0x11) | ∥ | //FIN/ACK |
| 3) | ((tcp[13:1] & 0x12) = 0x12) | ∥ | //SYN/ACK |
| 4) | ((tcp[13:1] & 0x14) = 0x14). | | //RST/ACK |

Thus, a packet having an analyzed signature indicating a TCP packet with a zeroed acknowledgment number and having any one of the above flag conditions 1)-4) will satisfy the inbound NMAP probe signature description.

While the identification of a TCP packet having an acknowledgment number of zero and an asserted ACK flag may indicate a likelihood that the TCP packet is involved in an NMAP probe, a text-based outbound signature may be provided that describes a likely response of a network stack generated in response to reception of one of the defined NMAP probe packets. The text-based description for an example suspect outbound network stack response signature corresponds to an analyzed packet generated from the network stack identified as a TCP packet with at least one of the 32-bit sequence number and 32-bit acknowledgment number of the identified TCP packet set to zero by the following condition:

((tcp)&&((tcp[4:4]=0)∥(tcp[8:4]=0))).

An evaluation of a correspondence of an analyzed signature of a packet generated by the network stack of the targeted node with the outbound signature of the text-based signature description is contingent on the identified TCP packet with an acknowledgment number set to zero or the sequence number set to zero and either, or both, of the Acknowledgment flag and Reset flag asserted by logically ANDing the TCP packet requirement having a zeroed sequence number or acknowledgment number with the following bitwise operation:

((tcp[13:1]&0x14)=0x14).

TABLE A
TCP INBOUND
if(

((tcp) && (tcp[8:4]=0)) &&
(

| | | |
|---|---|---|
| ((tcp[13:1] & 0x10) = 0x10) | ∥ | //ACK |
| ((tcp[13:1] & 0x11) = 0x11) | ∥ | //FIN/ACK |
| ((tcp[13:1] & 0x12) = 0x12) | ∥ | //SYN/ACK |
| ((tcp[13:1] & 0x14) = 0x14) | ∥ | //RST/ACK |
| ) | | |
| then | | |
| ACTION: LOG_FRAME | | |
| DIRECTION: INBOUND | | |
| endif | | |

TCP OUTBOUND
if(

| ((tcp) && ((tcp[4:4]=0) ∥ (tcp[8:4]=0))) && //ACK/SEQ=0 | |
|---|---|
| ((tcp[13:1] & 0x14) = 0x14) | //RST and ACK or ACK/RST |

)
then
ACTION: LOG_FRAME/DISCARD
DIRECTION: OUTBOUND

endif

As mentioned hereinabove, text-file 277A may provide a text-based signature description that, when compiled, results in generation of a machine-readable signature file having computer-readable logic representative of the signature described in text-file 277A. Additionally, text-file 277A may comprise one or more directives that will have corresponding machine-readable instructions that direct processing of a CPU 272 executing the machine-readable signature file upon confirmation of a correspondence between a signature of an analyzed packet and/or frame and the machine-readable logic representative of the signature description of text file 277A. The machine-readable signature file may then be used by IPS application 91, for example network filter service provider 140 and/or transport service provider 120, for comparing the machine-readable logic generated from compilation of the text-based signature for comparison with a signature of a packet and/or frame obtained through analysis thereof. An outbound signature description may be provided in a text-file as well and attacks that may not be conclusively identified by a packet and/or frame received at network stack 90A may be identified by comparing an outbound signature with a network stack packet and/or frame response to a possible hostile packet and/or frame received thereby. The exemplary text-based NMAP signature description comprises a directive, or action, directing network filter service provider to log the inbound packet, or frame, upon determination of a correspondence with the inbound signature. Additionally, confirmation of a correspondence between the packet and/or frame generated by the network stack with the outbound signature description of text file 277A may be made. An outbound signature directive may specify that the outbound packet and/or frame is to be logged, discarded, and/or the directive may specify another security measure, thus preventing the network stack response to the identified NMAP probe from reaching the media access control driver and thereby preventing the NMAP probing agent from receiving the NMAP response.

The present invention thus provides a technique for detecting a exploitative intrusion based on an outbound frame and/or packet generated by a node in response to a packet or frame received thereby. Additionally, intrusions that may be identified by an inbound or outbound signature thereof may have security measures specified in a directive executed upon identification of the inbound or outbound signature. Notably, identification of a packet and/or frame solely based on an outbound signature thereof may allow IPS 91 to deny a node of network 100 from being used in an attack on other nodes of network 100 or nodes of an external network. The IPS of the present invention having operability to perform exploit identification based on evaluation of an outbound packet and/or an evaluation of a previous inbound packet or frame may be implemented in machine-readable code and may be executed by any node of network 100 having a processor operable to read and execute the machine-readable code. The machine-readable code comprising logic for causing the described signature analysis process to be performed by a processor may be electronically delivered thereto or may be carried on a computer-readable medium such as magnetic disc, optical disc or another medium suitable for storage and delivery of machine-readable instruction sets.

[image]

What is claimed is:

1. A method of detecting an intrusion at a node of a network, comprising:
reading a first packet received by the node;
determining a first signature of the first packet;
comparing the first signature with a signature file comprising a first machine-readable logic representative of a first packet signature;
determining the first signature corresponds with the first machine readable logic;
reading a second packet generated by the node in response to reception of the first packet;
determining a second signature of the second packet;
comparing the second signature with the signature file further comprising a second machine-readable logic representative of second packet signature; and
determining the second signature corresponds with the second machine readable logic.

2. The method according to claim 1, further comprising executing a directive associated with the first machine readable logic upon determining the first signature corresponds with the first machine readable logic.

3. The method according to claim 1, further comprising executing a directive associated with the second machine readable logic upon determining the second signature corresponds with the second machine readable logic.

4. The method according to claim 3, wherein executing a directive associated with the second machine readable logic further comprises discarding the second packet.

5. The method according to claim 4, wherein discarding the second packet further comprises discarding the packet at the network layer of the network stack of the node.

6. The method according to claim 1, wherein reading a second packet generated by the node in response to reception of the first packet further comprises reading a second packet generated by a network stack of an operating system of the node.

7. A computer-readable medium having stored thereon a set of instructions to be executed, the set of instructions, when executed by a processor, cause the processor to perform a computer method of:
reading a first packet;
determining a first signature of the first packet;
comparing the first signature with a first instruction set comprising a first set of machine readable logic representative of a first packet signature;
determining the first signature corresponds with the first set of machine readable logic;
reading a second packet;
determining a second signature of the second packet;
comparing the second signature with a second instruction set comprising a second set of machine readable logic representative of a second packet signature; and
determining the second signature corresponds with the second set of machine readable logic.

8. The computer-readable medium according to claim 7, further comprising an instruction set that, when executed by the processor, causes the processor to perform the computer method of executing, upon determining the first signature corresponds with the first instruction set, a directive comprised of machine-readable instructions, the first instruction set comprising the directive.

9. The computer-readable medium according to claim 7, further comprising an instruction set that, when executed by the processor, causes the processor to perform the computer method of executing, upon determining the second signature corresponds with the second instruction set, a directive comprised of machine-readable instructions, the second instruction set comprising the directive.

10. The computer-readable medium according to claim 9, wherein executing a directive comprised of machine-readable instructions further comprises executing a directive that causes the processor to discard the second packet.

11. The computer-readable medium according to claim 10, wherein executing a directive that causes the processor to discard the second packet further comprises discarding a packet at a network layer of a network stack.

12. The computer-readable medium according to claim 7, wherein comparing the first signature with a first instruction set comprising a first set of machine readable logic representative of a packet signature further comprises performing a binary pattern comparison with the first signature and the first set of machine readable logic.

13. The computer-readable medium according to claim 7, wherein comparing the second signature with a second instruction set comprising a second set of machine readable logic representative of a packet signature further comprises performing a binary pattern comparison with the second signature and the second set of machine readable logic.

14. A node of a network operable to detect an intrusion thereof, comprising:
a central processing unit;
a memory module for storing data in machine readable format for retrieval and execution by a central processing unit; and
an operating system comprising a network stack comprising a protocol driver, a media access control driver and a network filter service provider bound to the protocol driver and the media access control driver, the network filter service provider operable to receive a first packet and to determine a first signature of the first packet and compare the first signature with a first instruction set comprising a first set of machine readable logic representative of a first packet signature and to determine a correspondence with the first set of machine readable logic, the network filter service provider further operable to receive a second packet and to determine a second signature of the second packet and compare the second signature with a second instruction set comprising a second set of machine readable logic representative of a second packet signature and to determine a correspondence with the second set of machine readable logic, the processor operable to execute a directive comprised of machine readable instructions upon determination, by the network filter service provider, of a correspondence between the first signature and the first instruction set and correspondence between the second signature and the second instruction set.

15. The node according to claim 14, wherein execution of the directive causes the network filter service provider to discard the second packet.

16. The node according to claim 14, wherein the first packet is received by the node and the second packet is generated by the node.

17. The node according to claim 14, wherein the first packet is generated by the node and the second packet is received by the node.

18. The node according to claim 14, wherein the network filter service provider further comprises a pattern matching algorithm, the comparison of the first signature with the first instruction set and the comparison of the second signature with the second instruction set performed by the pattern matching algorithm.

19. A method of detecting an intrusion at a node of a network, comprising:
reading a packet by the node;
determining a signature of the packet;
comparing the signature with a signature file comprising a machine-readable logic representative of a packet signature; and
determining the signature corresponds with the machine readable logic.

20. The method according to claim 19, wherein the packet is received by the node.

21. The method according to claim 19, wherein the packet is generated by the node and generation of the packet is made in response to reception of a first packet received by the node.

22. The method according to claim 19, wherein the packet is generated by the node, an evaluation made that the packet is a probe packet upon determining the signature corresponds with the machine readable logic.
